(19) United States
(12) Patent Application Publication
(10) Pub. No.: US 2007/0032753 A1
(43) Pub. Date: Feb. 8, 2007

(54) MUSICAL MASSAGE DEVICE

(76) Inventor: Michael R. HOFFMANN, Clive, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/161,410

(22) Filed: Aug. 2, 2005

(51) Int. Cl. A61H 1/00

(52) U.S. Cl. 601/78; 601/47; 601/80

(57) ABSTRACT

A massage device having a permanent magnet with a central opening. Disposed within the central opening of the permanent magnet is an electromagnetic coil. The coil is connected to a musical source adapted to generate an electrical signal corresponding to the music output. A flexible cover is fitted over an open end of the permanent magnet. The charge of the electrical signal causes the coil to interact with the permanent magnet and move back and forth within. As the coil moves, the coil engages the flexible cover pushing the cover away from the open end of the permanent magnet.

### BACKGROUND OF THE INVENTION

This invention is directed toward a massage or vibrating device, and more particularly to a massage device that vibrates based on a musical frequency.

Massage devices are well known in the art. Some of these devices include a musical source adapted to generate an electric signal corresponding to the music. As an example, U.S. Pat. No. 6,104,820 by Soza discloses a plurality of pads that receive an electrical signal from an amplifier. The intensity of the electrical signal is adjusted by a selection means. This device requires many parts and connections and has a limited vibrating motion. Accordingly, there is a need in the art for a massage device that addresses these problems.

Therefore, an objective of the present invention is to provide a massage device that is made with fewer parts.

Another objective of the present invention is to provide a massage device that has a vibrating movement based on the intensity of a musical frequency.

A still further objective is to provide a massage device that is both easy and economical to manufacture.

These and other objectives will be apparent to those skilled in the art based on the following description.

### SUMMARY OF THE INVENTION

A massage device having a permanent magnet with a central opening. Disposed within the central opening of the permanent magnet is an electromagnetic coil. The coil is connected to a musical source adapted to generate an electrical signal corresponding to the music output. A flexible cover is fitted over an open end of the permanent magnet. The charge of the electrical signal causes the coil to interact with the permanent magnet and move back and forth within. As the coil moves, the coil engages the flexible cover pushing the cover away from the open end of the permanent magnet.

### BRIEF DESCRIPTION OF THE DRAWINGS

FIG. 1 is a perspective view of a massage device; and

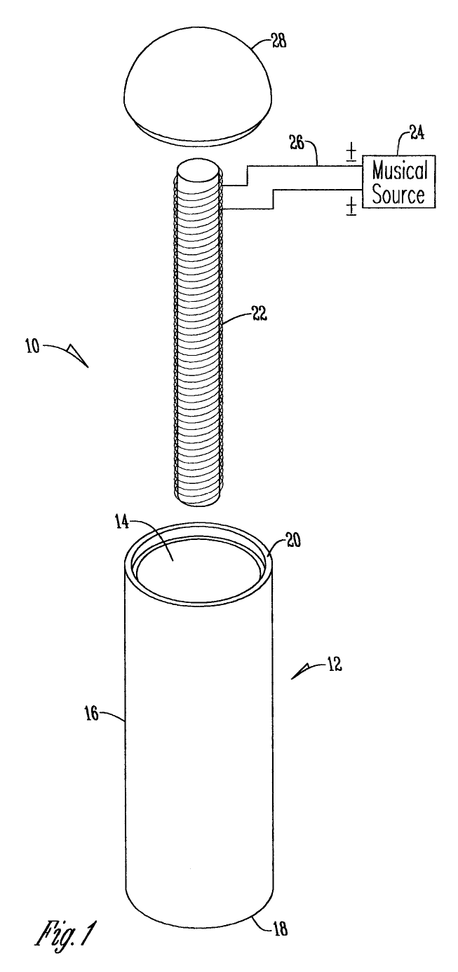

FIG. 2 is a side sectional view of a massage device.

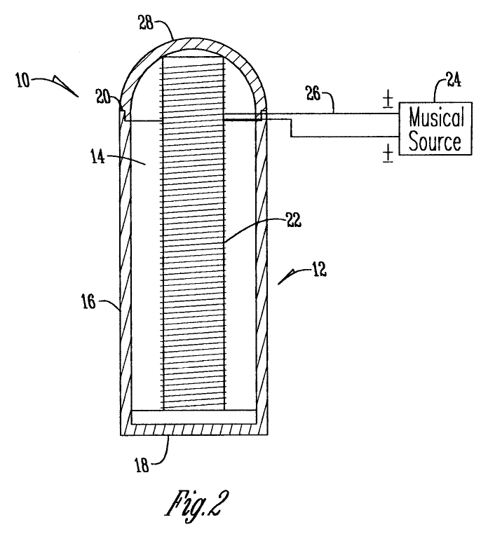

### DETAILED DESCRIPTION OF THE PREFERRED EMBODIMENT

Referring to the Figures, a massage device 10 has a permanent magnet 12 having a hollow center 14. The magnet 12 is of any size and shape, but preferably has an elongated cylindrical body 16 with a polarized closed end 18 and a polarized open end 20.

Disposed within the hollow center 14 of the magnet 12 is an electromagnetic coil 22. The electromagnetic coil 22 is of any type such as a coil of wire wrapped around a piece of magnetic metal such as iron or the like. The electromagnetic coil 22 is connected to a musical source 24 that is adapted to generate a musical electric signal corresponding to the music at an output. The electromagnetic coil 22 is connected to the musical source by a wire 26. Fitted over the open end 20 of body 16 is a flexible cover or cap 28.

In operation, once assembled, an electrical signal is supplied from the musical source 24 to the electromagnetic coil 22. The electronic signal provided by the musical source is constantly switching and fluctuating between a positive and a negative charge. Based on the charge received the electromagnetic coil 22 interacts with the permanent magnet 12. For example, when charged, the positive end of the electromagnetic coil 22 is attracted to the negative end of the permanent magnet 12, and the negative end of the electromagnetic coil 22 is attracted toward the positive end of the permanent magnet 12. When the charge is switched, the repulsion and attraction between the ends of the electromagnetic coil 22 and the ends of the permanent magnet 12 switches causing the coil 22 to move back and forth within magnet 12. As the coil 22 moves back and forth within magnet 12, an end of the coil engages the cover 28 pushing the cover 28 outwardly from end 20 of the body 16 creating a vibration similar to a tapping motion. The frequency and amplitude of the electrical signal received from the musical source 24 dictates the rate and distance that the coil 22 moves.

From this disclosure, a massage device has been described that at the very least satisfies the stated objectives.

What is claimed is:

1. A massage device, comprising:
a permanent magnet having a central opening;
an electromagnetic coil disposed within the central opening of the permanent magnet;
the electromagnetic coil connected to a musical source adapted to generate an electrical signal corresponding to the music; and
the electromagnetic coil being capable of movement within the permanent magnet based on the electrical signal.

2. The device of claim 1 wherein the permanent magnet has an elongated cylindrical body with a closed end and an open end.

3. The device of claim 2 wherein a flexible cover is fitted to the open end of the elongated body.

4. The device of claim 3 wherein the electromagnetic coil engages the flexible cover.
